(19) United States
(12) Patent Application Publication
(10) Pub. No.: US 2017/0175846 A1
(43) Pub. Date: Jun. 22, 2017

(54) PROPSHAFT LINER

(71) Applicant: GM GLOBAL TECHNOLOGY OPERATIONS LLC, DETROIT, MI (US)

(72) Inventor: Robert J. Considine, Brighton, MI (US)

(21) Appl. No.: 14/972,393

(22) Filed: Dec. 17, 2015

(51) Int. Cl. F16F 15/12; F16C 3/02

(52) U.S. Cl. CPC F16F 15/12; F16C 3/02; F16F 2224/02; F16F 2228/04

(57) ABSTRACT

A prop-shaft assembly comprises a hollow shaft having an axially extending inner chamber. A first liner comprises an axially extending, hollow tubular member having a resilient damping member fixed to, and extending outwardly from, the outer surface. A second liner comprises an axially extending, hollow tubular member having a resilient damping member, fixed to and extending outwardly from, the outer surface and having an outer diameter, including the resilient damping member, that is slightly less than an inner diameter of the hollow tubular member of the first liner to facilitate its insertion into the hollow tubular member of the first liner. The hollow shaft is configured to receive the first liner and the second liner, disposed in the first liner, in the axially extending inner chamber wherein the first and second liners operate to attenuate a first frequency and a second frequency during rotation of the prop-shaft.

### FIELD OF THE INVENTION

The subject of the disclosure is directed to the attenuation of noise and vibration generated by a rotating shaft and, more particularly, to a prop-shaft having concentric inner liners for the reduction more than one frequency of generated noise and induced vibration.

### BACKGROUND

Power transfer from rotating machinery is commonly transferred through the use of rotating shafts or prop-shafts; many of which are constructed of thin-walled, hollow tubing. These prop-shafts are known to be susceptible to the generation of sound and vibration at frequencies that may be undesirable and, therefore, may require attenuation. In vehicular applications, drivelines transmit rotational power from a powertrain (ex. engine and transmission) to driven wheels. Noise and vibration generated by the driveline may be viewed by customers/operators as undesirable and therefore must be reduced or eliminated. The various excitation sources (gear meshing, torsion) can typically cause a prop-shaft to vibrate in one or more of a bending mode, a torsional mode and a shell mode.

A common system for the reduction of noise and vibration in a vehicle prop-shaft is the insertion of a damping device into the hollow tube comprising the prop-shaft. The damping device is often a cardboard, or cardboard-like sleeve that is fixed in place using friction and or a press-fit, adhesives, etc. Location in the prop-shaft is important for the reduction of certain frequencies and a limitation of the described liners is that they are limited to addressing one frequency. It is desirable to provide a prop-shaft liner that is insertable into a prop-shaft and that will attenuate more than one frequency and that is operable to focus on one, or a multiple of modes.

### SUMMARY OF THE INVENTION

In an exemplary embodiment a prop-shaft assembly comprises a hollow shaft having an axially extending inner chamber defined by an inner wall. A first liner comprises an axially extending, hollow tubular member having a resilient damping member fixed to and extending outwardly from an outer surface. A second liner comprises an axially extending, hollow tubular member having a resilient damping member fixed to and extending outwardly from an outer surface and having an outer diameter, including the resilient damping member, that is slightly less than an inner diameter of the hollow tubular member of the first liner to facilitate its insertion into the hollow tubular member of the first liner. The hollow shaft is configured to receive the first liner and the second liner, disposed in the first liner, in the axially extending inner chamber wherein the first and second liners operate to attenuate a first frequency and a second frequency during rotation of the prop-shaft.

In another exemplary embodiment a vehicle has an engine that generates a torque output distributed through a prop-shaft assembly comprising a hollow shaft having an axially extending inner chamber defined by an inner wall. A first liner comprises an axially extending, hollow tubular member having a resilient damping member fixed to and extending outwardly from the outer surface. A second liner comprises an axially extending, hollow tubular member having a resilient damping member fixed to and extending outwardly from the outer surface and having an outer diameter, including the resilient damping member, that is slightly less than an inner diameter of the hollow tubular member of the first liner to facilitate its insertion into the hollow tubular member of the first liner. The hollow shaft is configured to receive the first liner and the second liner, disposed in the first liner, in the axially extending inner chamber wherein the first and second liners operate to attenuate a first frequency and a second frequency during rotation of the prop-shaft.

The above features and advantages, and other features and advantages of the invention, are readily apparent from the following detailed description of the invention when taken in connection with the accompanying drawings.

### BRIEF DESCRIPTION OF THE DRAWINGS

Other features, advantages and details appear, by way of examples only, in the following detailed description of the embodiments, the detailed description referring to the drawings in which:

FIG. 1 is a schematic plan view of a vehicle having a driveline and axle assemblies in accordance with embodiments of the invention;

FIG. 2 is an isometric view of a prop-shaft assembly embodying features of the invention;

FIG. 3 is a partial sectional view of the prop-shaft assembly of FIG. 2, taken along Line 3-3;

FIG. 4 is a partial, isometric view of a liner assembly embodying features of the invention;

FIG. 5 is a partial, disassembled view of the prop-shaft assembly of FIG. 2;

FIG. 6 is a sectional view of another embodiment of the liner assembly embodying features of the invention; and

FIG. 7 is a partial, disassembled view of the prop-shaft assembly of FIG. 2;

### DESCRIPTION OF THE EMBODIMENTS

The following description is merely exemplary in nature and is not intended to limit the disclosure, its application or uses. It should be understood that throughout the drawings, corresponding reference numerals indicate like or corresponding parts or features.

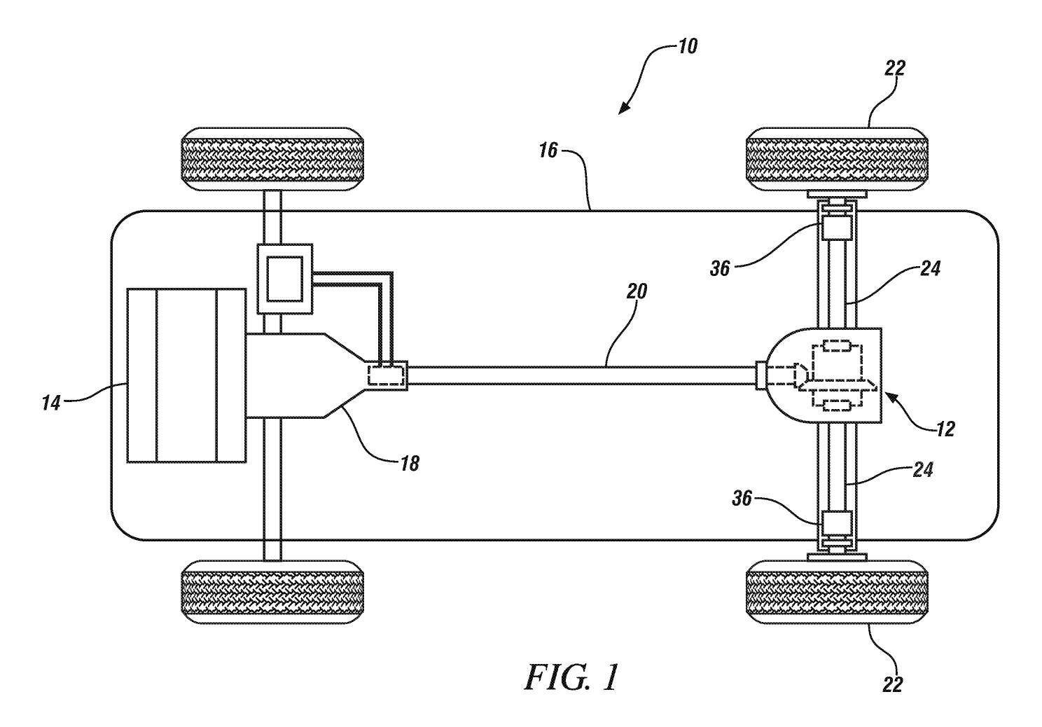

In accordance with an embodiment of the invention, FIG. 1 illustrates a vehicle 10 having a differential assembly 12. It should be appreciated that the vehicle 10 may be an automobile, a truck, a van or a sport utility vehicle, for example. As used herein, the term vehicle is not limited to just an automobile, a truck a van or a sport utility vehicle, but may also include any self-propelled or towed conveyance suitable for transporting a burden. The vehicle 10 may include an engine 14, such as a gasoline or diesel fueled internal combustion engine, for example. The engine 14 may further be a hybrid-type engine that combines an internal combustion engine with an electric motor. The engine 14 and the differential assembly 12 are coupled to a frame or other chassis structure 16. The engine 14 is coupled to the differential assembly through a transmission 18 and a driveshaft (a type of prop-shaft) 20. The transmission 18 may be configured to reduce the rotational velocity and increase the torque output of the engine 14. The rear differential assembly 12 transmits output torque from the driveshaft 20 to a pair of driven wheels 22 via axles (prop-shafts) 24.

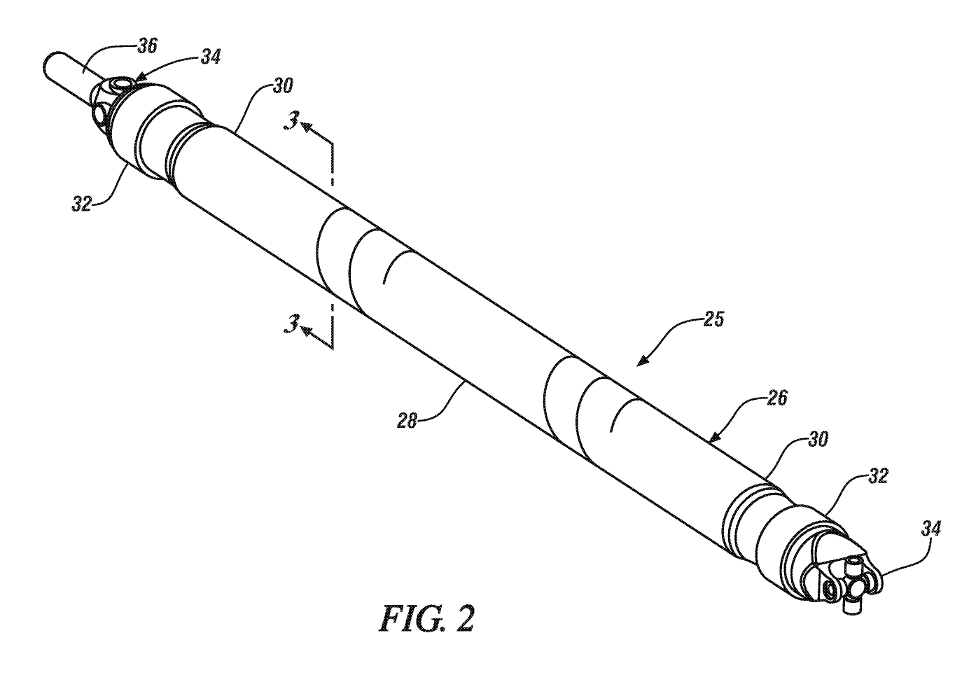

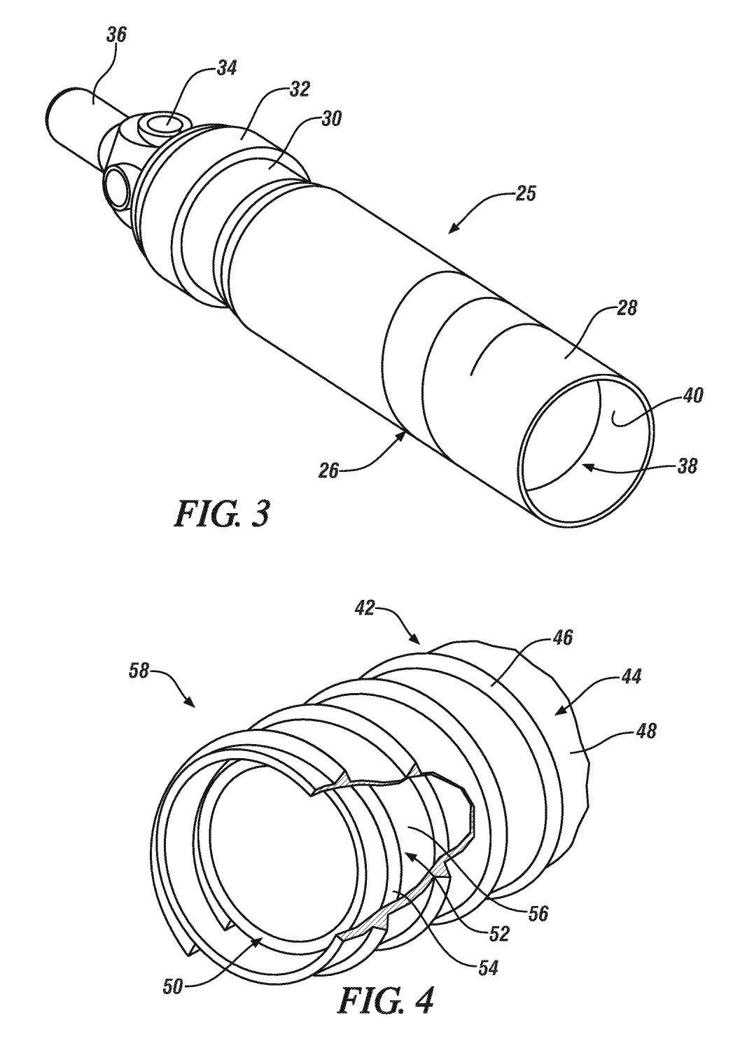

Referring now to FIGS. 2-5, with continuing reference to FIG. 1, in an embodiment, a prop-shaft assembly 25 comprises a hollow, thin-walled shaft 26 having a center portion 28 and end portions 30. The end portions may be closed by trunnion caps 32 having spiders 34 extending therefrom for attachment to output shafts 36 of either the transmission 18, the differential assembly 12 or the driven wheels 22 as universal joints 36, for example. It should be noted that the prop-shaft assembly 25 may comprise the driveshaft 20 and axle 24 or any other rotating shaft. The hollow shaft 26 has an axially extending inner chamber 38 defined by inner wall 40.

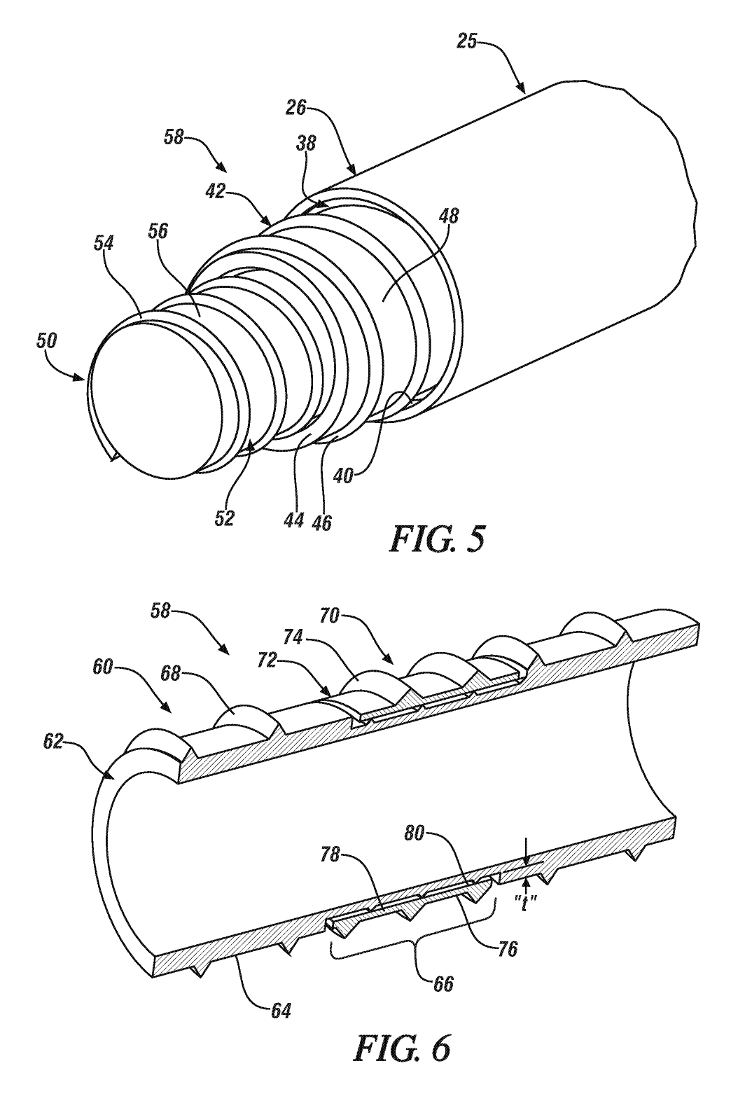

During operation/rotation of the prop-shaft assembly 25, various harmonic frequencies may be prevalent (torsional and harmonic frequencies) at certain rotational speeds. To address these frequencies, which may result in unwanted noise and/or vibration, a first liner 42 comprises an axially extending, hollow tubular member 44 that may be constructed of one or more plies of wound paperboard or other suitable fibrous material. Examples of other suitable materials may include, but are not limited to cardboard, plastic sheet, carbon fiber, fiberglass, metal sheet and a combination thereof. A resilient damping member 46 is fixed to and extends outwardly from the outer surface 48 of the hollow tubular member 44 of the first liner 42. The first liner 42 is inserted into the axially extending inner chamber 38 of the hollow shaft 26, FIG. 5, where the resilient damping member 46 enables a press or friction fit between the first liner and the inner wall 40 of the inner chamber 38. The first liner 42 may be co-extensive with the length of the hollow, thin-walled shaft 26 or it may extend a portion of the axial length thereof. Its length, construction and location are determined by a particular first frequency, in an exemplary embodiment 300-400 Hz, that is to be attenuated during the rotation of the prop-shaft assembly 25.

Circumstances may arise that dictate more than one noise or vibration frequency (i.e. a second frequency) be attenuated in the prop-shaft assembly 25. In such an instance, a single liner 42 of the type just described is ill-suited to perform such a task. In an exemplary embodiment, a second liner 50 comprises an axially extending, hollow tubular member 52 that may be constructed of one or more plies of wound paperboard or other suitable fibrous material. Examples of other suitable materials may include, but are not limited to cardboard, plastic sheet, carbon fiber, fiberglass, metal sheet and a combination thereof. A resilient damping member 54 is fixed to and extends outwardly from the outer surface 56 of the hollow tubular member 52 of the second liner 50. In the embodiment, the second liner 50 has an outer diameter, including the resilient damping member 54, that is slightly less than the inner diameter of the hollow tubular member 44 facilitating its insertion into the hollow tubular member 44 of the first liner 42 where the resilient damping member 54 enables a press or friction fit between the first liner 42 and the second liner 50. The second liner 50 may be co-extensive with the length of the first liner 42 or it may extend a portion of the axial length thereof. Its length and location is determined by the particular second frequency, in an exemplary embodiment 300-600 Hz, that is to be attenuated during the rotation of the prop-shaft assembly 25. As a result of the described configuration of first and second liners 42 and 50 within the hollow, thin-walled shaft 26 of the prop-shaft assembly 25, a liner assembly 58 has been described by which multiple frequencies are now attenuated.

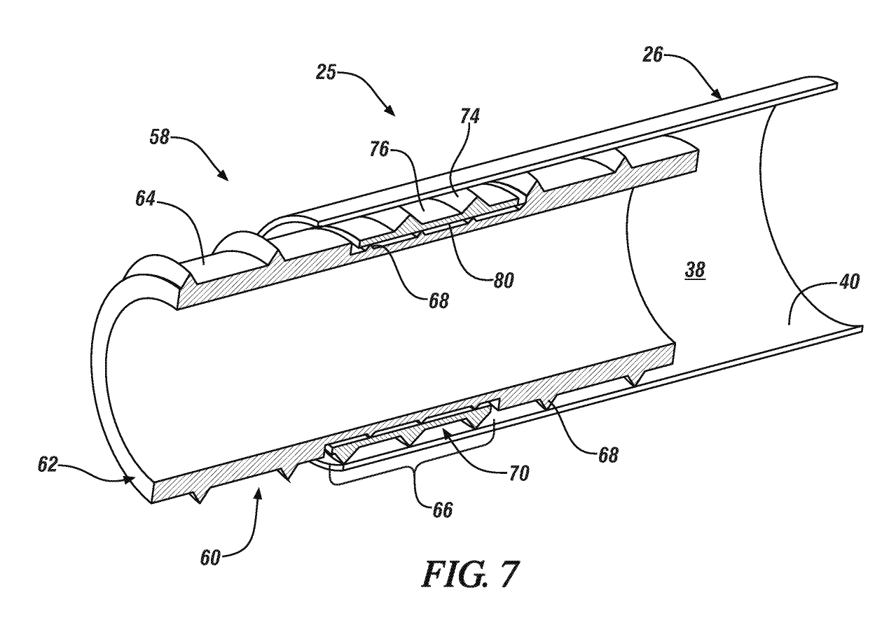

Referring now to FIGS. 6 and 7, with continuing reference to FIG. 1, in another embodiment of the liner assembly 58, a first liner 60 comprises an axially extending, hollow tubular member 62 that may be constructed of one or more plies of wound paperboard or other suitable fibrous material. Examples of other suitable materials may include, but are not limited to cardboard, plastic sheet, carbon fiber, fiberglass, metal sheet and a combination thereof. At a location along the outer surface 64 of the hollow tubular member 62, a region of reduced diameter 66, having a thickness “t”, is defined. The region of reduced diameter 66 may extend any of a number of predetermined lengths and/or thicknesses, to be described in further detail herein. A resilient damping member 68 is fixed to and extends outwardly from the outer surface 64 of the hollow tubular member 62 of the first liner 60.

A second liner 70 comprises an axially extending, hollow tubular member 72 that may be constructed of one or more plies of wound paperboard or other suitable fibrous material. Examples of other suitable materials may include, but are not limited to cardboard, plastic sheet, carbon fiber, fiberglass, metal sheet and a combination thereof. A resilient damping member 74 is fixed to and extends outwardly from the outer surface 76 of the hollow tubular member 72 of the second liner 70. In an embodiment, the thickness of the second liner 70, which includes a wall 78 of the hollow tubular member and the resilient damping member 74, is selected to closely match the thickness “t” of the region of reduced diameter 66. The second liner 70 may be assembled around the surface 64 of the hollow tubular member 62 of the first liner 60 in the region of reduced diameter 66.

Assembly of the second liner 70 onto the first liner 60 may involve the use of an adhesive; it may utilize resilient damping members situated on the region of reduced diameter 66 and operable to frictionally engage the inner wall 80 of the hollow tubular member 72 or any other means for fixing the two tubular members. The second liner 70 may extend any portion of the axial length of the first liner 60. Its length and location is determined by the particular second frequency that is to be attenuated during the operation of the prop-shaft assembly 25. The resulting liner assembly comprises first and second liners 60 and 70, in which second liner is coaxially located about the first liner 60 in a region of reduced diameter 66, such that the addition of the second liner 70 adds little or no additional radial thickness to the liner assembly 58. The liner assembly 58 is inserted into the axially extending inner chamber 38 of the hollow shaft 26 where the resilient damping members 68 and 74 enable a press or frictional fit between the first liner 60 and the inner wall 40 of the inner chamber 38 and the second liner 70 and the inner wall 40 of the inner chamber 38. The liner assembly 58 may be co-extensive with the length of the hollow, thin-walled shaft 26 or it may extend a portion of the axial length thereof. Its length, construction and location are determined by particular first and second frequencies that are to be attenuated during the operation of the prop-shaft assembly 25.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiments disclosed, but that the invention will include all embodiments falling within the scope of the present application.

What is claimed is:

1. A prop-shaft assembly comprises:
a hollow shaft having an axially extending inner chamber defined by an inner wall;
a first liner comprising an axially extending, hollow tubular member having a resilient damping member fixed to and extending outwardly from an outer surface;
a second liner comprising an axially extending, hollow tubular member having a resilient damping member fixed to and extending outwardly from an outer surface and having an outer diameter, including the resilient damping member, that is slightly less than an inner diameter of the hollow tubular member of the first liner to facilitate its insertion into the hollow tubular member of the first liner; and
the hollow shaft configured to receive the first liner and the second liner, disposed in the first liner, in the axially extending inner chamber wherein the first and second liners operate to attenuate a first frequency and a second frequency, respectively, during rotation of the prop-shaft.

2. The prop-shaft of claim 1, wherein the second liner is co-extensive with an axial length of the first liner.

3. The prop-shaft of claim 1, wherein the second liner extends a portion of an axial length of the first liner.

4. The prop-shaft of claim 1, wherein a length of the first and second liners and a location of the liners in the hollow shaft varies by the frequencies to be attenuated during the operation of the prop-shaft.

5. The prop-shaft of claim 4, wherein the first liner attenuates a frequency in the range of 300-400 Hz.

6. The prop-shaft of claim 4, wherein the second liner attenuates a frequency in the range of 300-600 Hz.

7. The prop-shaft of claim 1, wherein the resilient damping member enables a press or friction fit between the first liner and the inner wall of the inner chamber.

8. The prop-shaft of claim 1, wherein the resilient damping member of the second liner enables a press or friction fit between the first liner and the second liner.

9. The prop-shaft of claim 1, wherein the hollow tubular members of the first and second liners are constructed from one of more of wound paperboard or other suitable fibrous material, cardboard, plastic sheet, carbon fiber, fiberglass, metal sheet or a combination thereof.

10. A vehicle having an engine generating a torque output, distributed through a prop-shaft assembly comprising:
a hollow shaft having an axially extending inner chamber defined by an inner wall;
a first liner comprising an axially extending, hollow tubular member having a resilient damping member fixed to and extending outwardly from an outer surface thereof;
a second liner comprising an axially extending, hollow tubular member having a resilient damping member fixed to and extending outwardly from an outer surface and having an outer diameter, including the resilient damping member, that is slightly less than an inner diameter of the hollow tubular member of the first liner, to facilitate its insertion into the hollow tubular member of the first liner, wherein the hollow shaft is configured to receive the first liner and the second liner, disposed in the first liner, in the axially extending inner chamber wherein the first and second liners operate to attenuate a first frequency and a second frequency, respectively, during rotation of the prop-shaft.

11. The vehicle of claim 10, wherein the second liner is co-extensive with an axial length of the first liner.

12. The vehicle of claim 10, wherein the second liner extends a portion of an axial length of the first liner.

13. The vehicle of claim 10, wherein a length of the first and second liners and a location of the liners in the hollow shaft varies by the frequencies to be attenuated during the operation of the prop-shaft.

14. The vehicle of claim 13, wherein the first liner attenuates a frequency in the range of 300-400 Hz.

15. The vehicle of claim 13, wherein the second liner attenuates a frequency in the range of 300-600 Hz.

16. The vehicle of claim 10, wherein the resilient damping member enables a press or friction fit between the first liner and the inner wall of the inner chamber.

17. The vehicle of claim 10, wherein the resilient damping member of the second liner enables a press or friction fit between the first liner and the second liner.

18. The vehicle of claim 10, wherein the hollow tubular members of the first and second liners are constructed from one of more of wound paperboard or other suitable fibrous material, cardboard, plastic sheet, carbon fiber, fiberglass, metal sheet or a combination thereof.
